(19) United States
(12) Patent Application Publication
(10) Pub. No.: US 2023/0260309 A1
(43) Pub. Date: Aug. 17, 2023

(54) TABLE EXTRACTION FROM IMAGE-BASED DOCUMENTS

(71) Applicant: Oracle International Corporation, Redwood Shores, CA (US)

(72) Inventors: Yazdan Jamshidikhezeli, Campbell, CA (US); Iman Zadeh, Los Angeles, CA (US); Jun Qian, Bellevue, WA (US)

(73) Assignee: Oracle International Corporation, Redwood Shores, CA (US)

(21) Appl. No.: 17/835,813

(22) Filed: Jun. 8, 2022

Related U.S. Application Data
(60) Provisional application No. 63/310,872, filed on Feb. 16, 2022.

(51) Int. Cl. G06V 30/414; G06V 30/10; G06V 30/19

(52) U.S. Cl. CPC G06V 30/414; G06V 30/10; G06V 30/19107

(57) ABSTRACT

Techniques are described for extracting tables and associated content from image-based documents and generating a machine-readable representation of a table. A system is described that executes an end-to-end pipeline for extracting one or more tables from an image-based documents and generating a machine-readable and editable table representation based upon the extracted contents. The processing may include using OCR techniques to extract text portions from an image-based document, identifying a region (table region) in the image-based document containing a table, identifying a subset of text portions that are located inside the table region, determining a number of rows and columns in the table to be generated, aligning the text portions and assigning row and column indices to the text portions, and generating a machine-readable table representation based upon the text portions.

### CROSS-REFERENCE TO RELATED APPLICATIONS

The present application is a non-provisional application of and claims the benefit and priority under 35 U.S.C. 119(e) of U.S. Provisional Application No. 63/310,872, filed on Feb. 16, 2022 entitled “TABLE EXTRACTION FROM IMAGE-BASED DOCUMENTS,” the entire contents of which is incorporated herein by reference for all purposes.

### BACKGROUND

Extracting content from images is a non-trivial and difficult task. An image from which content is to be extracted may have been generated by a scanner from scanning a document, by a camera from capturing an image of a document, and the like. The content in the image can include one or more words, lines of text, paragraphs, tables, images, etc. Since the image is of a document, the image is referred to as an image-based document. This is in contrast to a text-based document, which is a document created using an editor (e.g., Microsoft WORD, EXCEL) and in which the contents of the document, such as words, tables, etc., are preserved in the document and are easily extractable from the document. In contrast, in an image-based document, the words, tables, etc., are lost and not preserved—instead, an image-based document comprises pixels and the contents of the document are embedded in the values of the pixels. Examples of image-based documents include a scan or photograph of a receipt, a page of a book, and the like.

Given an image-based document, for several tasks, it is desirable that the contents of the image-based document be accurately extracted from the image-based document. Since many image-based documents contain content in the form of tables, it is important that such tables be identified, and their contents accurately extracted from the image-based document. For example, a user may take a photograph of a receipt and submit the photograph to his/her Accounting department for reimbursement. In many cases, a person in the Accounting department then manually processes the submitted photograph to extract information about the user's expenses, and then processes the user's reimbursement. This is however extremely labor intensive, time consuming, and expensive, and thus not very scalable.

Automated techniques have been introduced to automate the task of extracting content from an image-based document, and more particularly, to extract tables from an image-based document and to convert the content into an editable form or machine-readable form. This is a difficult and compute intensive task given the different variations in which a table can be represented in an image-based document. For example, the tables can be of different sizes (e.g., different numbers of rows and columns, different and potentially unequal sizes of cells), have different styles (e.g., with borders, without borders, without demarcation of rows and columns), and have different formats (e.g., ambiguous structures). The image-based document itself may be of bad quality (e.g., low resolution, presence of noise) making the extraction task even more difficult. The automated techniques use multistage processing pipelines that need high-speed computational resources and suffer from high latency, and due to the complexity of the task, suffer from high error rates.

More recently, machine-learning (ML) based techniques have started being used for extracting tables from image-based documents. These techniques however require an extensive amount of training data, which is difficult to obtain. Even when such training data is available, these ML-based techniques are computationally expensive. Due to the variety of tables, these ML-based techniques also tend to be error-prone.

### BRIEF SUMMARY

The present disclosure relates to extracting contents from image-based documents, and more particularly to improved techniques for extracting tables and associated content from image-based documents and generating a machine-readable representation of a table. Various embodiments are described herein, including methods, systems, non-transitory computer-readable storage media storing programs, code, or instructions executable by one or more processors, and the like.

In certain embodiments, techniques are described for identifying one or more tables in an image-based document, extracting the contents of the tables, and generating a machine-readable and editable representation for each extracted table. The techniques described herein are less compute intensive and faster than existing table extraction techniques. The techniques described herein are also more robust (i.e., less error prone) and accurate than existing table-extraction techniques, making the described techniques well suited for extracting tables from image-based documents that have been traditionally difficult for existing table extraction techniques to process, such as, for example, extracting tables from images of receipts.

A system (referred to as the table identification and extraction system) is described that executes an end-to-end pipeline for extracting one or more tables from an image-based documents and generating a machine-readable and editable table representation based upon the extracted contents. According to certain implementations, processing performed by the table identification and extraction system comprises: using optical character recognition (OCR) techniques to extract text content (in the form of one or more text portions) from an image-based document; based upon the extracted text, identifying a region (table region) in the image-based document containing a table; identifying a subset of text portions that are located inside the table region in the image-based document; based upon the text portions located within the table region, determining a number of rows and columns in the table to be generated; finding an alignment for the text portions inside the table region and assigning row and column coordinates to the text portions based upon the alignment; and generating a machine-readable table representation based upon the text portions and their assigned row and column coordinates.

The machine-readable representation that is generated by the table identification and extraction system can be in various forms such as an editable table, a spreadsheet (e.g., an EXCEL spreadsheet), a JSON (JavaScript Object Notation) object, an XML file or object, and the like. The machine-readable representation generated by the table identification and extraction system may then be provided to some downstream consumer of the machine-readable table representation.

In certain implementations, the image-based document processing pipeline described herein is performed on a line-by-line basis. This line-by-line processing and the order in which the processing is performed provide many of the technical improvements over existing techniques. For example, the OCR is applied to the image-based document on a line-by-line basis and line text portions are extracted from the image-based document. The line portions are then used to identify a table region within the image-based document. Line portions falling within the identified table region are then determined and used the table contents including the contents of the rows and columns in the table.

According to certain embodiments, techniques (e.g., a method, a system, or code or instructions executable by one or more processors) are provided for extracting a table from an image-based document. The technique includes obtaining an image-based document. The image-based document can include one or more tables. The image-based document can be processed to extract text portions. Each of the text portions can be bounded by a bounding box providing a position of each text portion in the image-based document. In some instances, an optical character recognition (OCR) process can be used to extract the text portions by generating the text portions into a machine-readable format. The image-based document can also be processed to detect a region that includes a table. A region within the image-based document comprising the table can be bounded by a bounding box including two-dimensional coordinates specifying a position of the table in the image-based document.

The text portions can be further processed to identify text portions that are within the region that includes the table. These text portions within the region that includes the table can include cells for the table. These text portions can be processed to identify a total number of rows and columns for the table as well as assign a row and column identifier for each cell.

In some instances, a row index and column index can be allocated to the cells to use in identifying the number of rows and columns for the table. The row and column identifiers can be assigned using a table structural segmentation (TSS) process using the allocated row index and column index. Further, in some instances, deriving the number of rows and columns for the table includes expanding each of the bounding boxes for the subset of the series of text portions until coordinates of the bounding box correspond with coordinates of any other bounding box.

In some instances, an alignment of each cell can be used to assign row and column identifiers for the cells. The alignment can be identified using a derived coordinate position of each cell within the table. Further, in some instances, clustering can be used to assign row and column identifiers for the cells. The clusters can group multiple subsets of the cells as part of a common row or column based the subset of cells comprising any coordinate within a threshold similarity to one another.

The row and column identifiers assigned to the cells can be used to generate a machine-readable version of the table. The generated table can be provided to a table processing system for subsequent processing.

The foregoing, together with other features and embodiments will become more apparent upon referring to the following specification, claims, and accompanying drawings.

### BRIEF DESCRIPTION OF THE DRAWINGS

FIG. 1 is a simplified block diagram of a table identification and extraction system according to an exemplary embodiment.

FIG. 2 provides a first set of example image-based documents comprising tables.

FIG. 3 provides a second set of example image-based documents comprising tables.

FIG. 4 depicts a simplified flowchart depicting processing performed for extracting a table from an image-based document and generating a machine-readable table representation corresponding to the table according to certain embodiments.

FIG. 5A is an example image-based document, according to at least one embodiment.

FIG. 5B illustrates the identified table and cells of the table in the image-based document, according to at least one embodiment.

FIG. 5C illustrates an example table in a machine-readable format, according to at least one embodiment.

FIG. 6 is a block diagram of a table comprising a number of cells with alignment position and grouped by multiple clusters, according to at least one embodiment.

FIG. 7 is a flow diagram of an example process for training a model, according to at least one embodiment.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.”

The present disclosure relates to extracting contents from image-based documents, and more particularly to improved techniques for extracting tables and associated content from image-based documents and generating a machine-readable representation of a table (also referred to as machine-readable table representation).

As previously indicated, extracting content from an image or image-based document is a non-trivial and difficult task. The task is additionally complicated when the contents to be extracted is a table. For purposes of this disclosure, an image-based document is a document comprising pixels. An image-based document may be generated using an imaging device such as a scanner (e.g., by from scanning a document) or a camera (e.g., by a camera from capturing an image of a document, and the like). An image-based document is different from a text-based document, which is a document created using an editor (e.g., Microsoft WORD, EXCEL) and in which the contents of the document, such as words, tables, etc., are preserved in the document and are easily extractable from the document. In contrast, in an image-based document, the words, tables, etc., are lost and not preserved—instead, an image-based document comprises pixels and the contents of the document are embedded in the values of the pixels. Examples of image-based documents include an image of a receipt containing multiple text lines (e.g., a list of items with corresponding quantities, and prices), an electronically scanned page of a book or article, and the like. Examples of image-based documents include files with “.jpeg”, “.gif”, “.png”, and “.tiff” file name extensions.

The task of extracting tables from an image-based document (e.g., an image of a receipt) can be done manually. This is however extremely labor intensive, time consuming, and expensive, and thus not very scalable. The automated techniques that are presently used to perform this task need high-speed computational resources and suffer from high latency, and additionally suffer from high error rates. Machine-learning (ML) based techniques that are recently being used for extracting tables from image-based documents require an enormous amount of training data, which is difficult to obtain. Even the ML-based techniques are computationally expensive and tend to be error-prone.

The techniques described herein provide significant improvements over conventional table extraction techniques. For example, the techniques described herein are less compute intensive and faster than existing table extraction techniques. The techniques described herein are also more robust (i.e., less error prone) and more accurate than existing table-extraction techniques. Example embodiments are well suited for extracting tables from image-based documents that have been traditionally difficult for existing table extraction techniques to process, such as, for example, extracting tables from images of receipts. The resource and latency/time savings provided by the embodiments described herein enable the table extraction processing to be performed in real time while consuming fewer computational resources that conventional techniques.

The techniques and systems described in this disclosure can be used to extract various different types and formats of tables from image-based documents. For example, the tables can have various different numbers of rows and columns, different sizes of rows and columns, tables with different styles (e.g., with borders, without borders, without demarcation of rows and columns), and with different formats (e.g., ambiguous structures with different alignment of the table cells). The techniques described herein can also be used to accurately extract tables from image-based documents with degraded quality, such as image-based documents with low resolution, with presence of noise, images captured in low light), which present challenges for conventional table extraction techniques. The image-based documents can be in color or in grey scale (or black and white) or a mix.

A system (referred to as the table identification and extraction system) is described that executes an end-to-end pipeline for extracting one or more tables from image-based documents and generates a machine-readable and editable table representation based upon the extracted contents. According to certain implementations, the table identification and extraction system uses optical character recognition (OCR) techniques to extract text content (in the form of one or more text portions) from an image-based document. An extracted text portion may be associated with position coordinates identifying the position of the text portion within the image-based document.

One or more regions (called table regions) within the image-based document that may contain tables are then identified. In an example embodiment, different techniques may be used to identify the table regions, including one or more machine learning techniques. For example, a model trained to detect table regions within an image-based document may be used to detect a table region within the image-based document. An example embodiment provides a model that is capable of determining boundaries in a table. Since the model is able to determine the boundaries of a table within the image-based document, and does not need to determine the boundaries of individual cells within a table or determine cell bounding boxes, the model can be simple and requires a lot less training data than conventional techniques. Further, since the training data only has to be annotated with table boundaries in image-based documents, and not boundaries of individual cells in the tables and their respective content, the type of training data is also easier to obtain. The training data only needs to label boundaries of tables and not corresponding cells.

Since the ratio of cells to tables in a receipt document can be very high, annotating just the position of tables is a simpler task, thus reducing the need for compute-intensive processing. Further, as described below, one or more automated training data generation techniques may be used to generate and augment and increase the volume of the training data generated from other sources.

From the text portions extracted from the image-based document using OCR, a subset of the text portions that are located inside a table region in the image-based document are then determined. Each of the subset of the text portions correspond to cells within the table. A number of rows and columns in the table to be generated are identified based upon the identified cells. In some implementations, deriving the number of rows and columns for the table includes expanding each of the bounding boxes for the subset of the text portions until they reach a neighboring bounding box. An alignment is then determined for the cells, and based upon the alignment, row and column coordinates are assigned to the cells. For example, a row index and a column index are assigned to a text portion in the subset. In certain implementations, allocating the row index and column index can be performed via a table structural segmentation (TSS) process. The row and column identifiers can be assigned to a cell based on the coordinate positions of the cell. Various techniques, such as clustering and others, may be used to determine the alignment of the cells and to assign the row and table coordinates.

The table identification and extraction system then can generate a machine-readable table representation based upon the cells and their assigned row and column coordinates. The cells represent cells of the machine-readable table representation. The row and columns coordinates assigned to the cells specify the position of each cell within the machine-readable table representation and the text portion corresponding to a cell is the content or value in that table cell in the machine-readable representation. For example, a machine-readable table representation can be generated that includes each of the subset of text portions arranged according to the assigned row identifiers and column identifiers.

Since the processing involving determining the number of rows and columns, ascertaining alignment of the cells, and assigning row and column coordinates is performed only on the cells (i.e., only on the extracted text portions that fall within a table region) and not on all text portions that are extracted from the image-based document, the processing is more efficient and faster than conventional techniques. The processing does not require compute-intensive resources and does not suffer from latency problems.

Additionally, the processing works on the cells that have been extracted using OCR and does not require a further mapping from the extracted content to cells of a table that is performed in conventional table extraction techniques. By eliminating this mapping, the table extraction processing is made faster and less compute intensive.

The machine-readable representation that is generated by table identification and extraction system can be in various forms such as an editable table, a spreadsheet (e.g., an EXCEL spreadsheet), a JSON (JavaScript Object Notation) object, an XML file or object, and the like. The machine-readable representation for a table comprises table data, providing text extracted from each of the subset of text portions in a machine-readable format (e.g., Unicode).

The machine-readable representation generated by the table identification and extraction system may then be provided to some downstream consumer of the machine-readable table representation. For example, the table data can be provided to an application that is configured to track, process, or act upon various aspects of the table data. The table machine-readable representation can be stored in a data repository for subsequent querying/retrieval.

As an illustrative example, consider that the image-based document to be processed is an image of a receipt. For example, while travelling for work, a user may have eaten dinner at a restaurant and obtained a paper receipt. The user may then have taken a photo of the paper receipt using the user's camera (e.g., using the user's mobile phone) and emailed or texted the resultant image to his employer for reimbursement. The receipt image-based document may be received by a table identification and extraction system used by the employer for automating the reimbursement processing. The table identification and extraction system may use OCR to extract text portions from the receipt image-based document. A table region may then be identified in the image-based document. A subset of text portions (cells) located in the table region may then be identified. A table region within the receipt image-based document is determined and a subset of the extracted test portions that are located within the table region are identified. A number of rows and columns for the table in the table region is determined. Row and column coordinates are assigned to the text portions in the subset (e.g., a row identifier and a column identifier for a text portion in the subset). A machine-readable table representation is then generated based upon the text portions in the subset and row and column coordinates assigned to those text portions. For example, the machine-readable table representation may be in the form of a JSON object that includes information identifying the various cells of a table and the contents of the cells. In the present example, the machine-readable table representation may comprise multiple rows and columns. The rows may correspond to items that the user ordered for dinner, with one row per item. The columns in the machine-readable representation may include a first column identifying the food items ordered by the user, and a second column listing the corresponding process of the food items identified in the first column. The machine-readable table representation may then be processed by an application to determine the reimbursement amount.

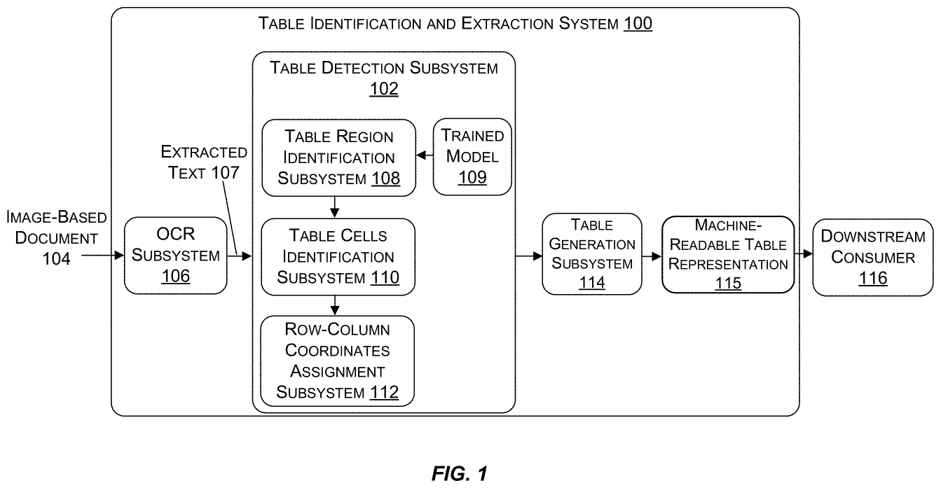

FIG. 1 is a simplified block diagram of a table identification and extraction system 100 according an exemplary embodiment. Table identification and extraction system 100 may comprise multiple systems and subsystems communicatively coupled to each other. The systems and subsystems in the embodiment in FIG. 1 include an optical character recognition (OCR) subsystem 106, a table detection subsystem 102, and a table generation subsystem 114. Table detection subsystem 102 includes a table region identification subsystem 108, a table cells identification subsystem 110, and a row-column coordinates assignment subsystem 112. The various systems and subsystems depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

Table identification and extraction system 100 depicted in FIG. 1 is merely an example and is not intended to unduly limit the scope of claimed embodiments. Many variations, alternatives, and modifications are possible. For example, in some implementations table identification and extraction system 100 may have more or fewer systems or components than those shown in FIG. 1, may combine two or more systems, or may have a different configuration or arrangement of systems.

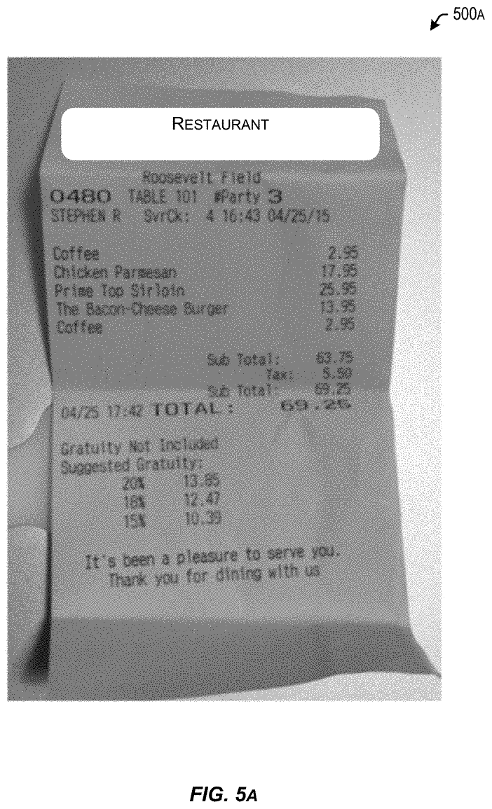

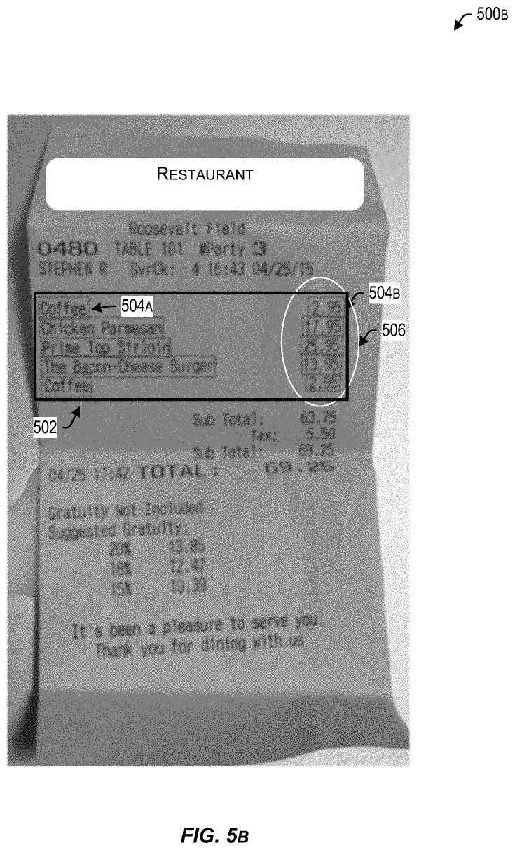

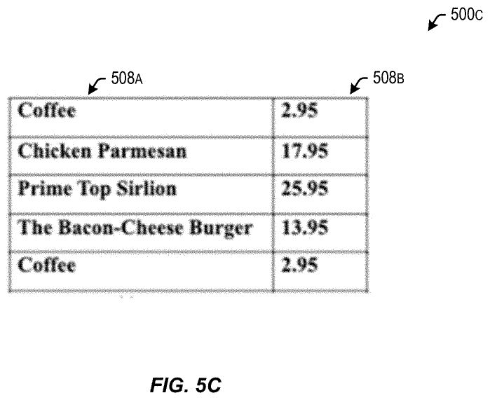

The table identification and extraction system 100 can obtain an image-based document 104. This can include receiving one or more image-based documents from a scanning model electronically scanning one or more input images. As another example, the image-based document 104 can be obtained from a client device capturing an image of a document. As an illustrative example, a client, using a camera on a mobile device, can capture an image of a receipt, which can be provided to the table identification and extraction system 100 as an image-based document. In some instances, the table identification and extraction system 100 can obtain and process a stream of image-based documents (e.g., as pages in a book, as a stream of receipts from a client device). FIG. 5A is an example image-based document, according to at least one embodiment. Specifically, an example of an image-based document 104 is provided in document 500A in FIG. 5A.

The OCR subsystem 106 can utilize an OCR technique to extract text from the image-based document 104. The OCR subsystem 106 can provide the extracted text 107 to the table detection subsystem 102. As described above, table detection subsystem 102 includes a table region identification subsystem 108, a table cells identification subsystem 110, and a row-column coordinates assignment subsystem 112. The table detection subsystem 102 can obtain the extracted text 107 and perform processing as described herein.

For instance, the table region identification subsystem 108 can process the extracted text 107 in the image-based document 104 to identify a region that comprises the table. This can include processing each text portion extracted from the image-based document 104 (e.g., from extracted text 107) to identify a region comprising a table. The region can be bounded by a bounding box specifying the coordinates of the region in the image-based document. FIG. 5B illustrates the identified table and cells of the table in the image-based document, according to at least one embodiment. The document 500B in FIG. 5B can be processed to identify a table 502. The identified table 502 can include a number of text portions (e.g., 504A, 504B) as comprising cells in the table 502. The table detection subsystem 102 can utilize a trained model 109 for identifying a table region in the image-based document. The image-based document with extracted text portions and the region identifying a table can be provided to table cells identification subsystem 110.

The table cells identification subsystem 110 can identify cells within the table. For example, the table can include a number of cells, with each cell including a portion of text. FIG. 5C illustrates an example table in a machine-readable format, according to at least one embodiment. In FIG. 5C, each cell can include text portions, with a first column including the text portions “Coffee,” “Chicken Parmesan,” “Prime Top Sirloin,” etc. Further, in this example, a second column can include the text portions including “2.95,” “17.95,” “25.95,” etc. The table cells identification subsystem 110 can process a positioning of the text portions within the table to identify a number of rows/columns for the table. The table cell data can be provided to a row-column coordinates assignment subsystem 112 to assign row/column identifiers for each text portion within the table region.

The row-column coordinates assignment subsystem 112 can assign each text portion within the table region with a row and column identifier. The row and column identifiers can specify a location in the table for each text portion within the table. In some instances, an alignment of each text portion and/or clustering techniques can be used to assign rows and columns for each text portion.

The table generation subsystem 114 can use the assigned row/column identifiers along with the extracted text portions to generate a machine-readable representation of the table 115. For example, in FIG. 5C, an example table 500C can be generated based on the table identified in FIG. 5B. The generated table can be searchable such that subsequent actions can be performed using the table data. For example, the table data can be added to a data repository or used in an application. The machine-readable representation of the table 115 can be provided to a downstream consumer, such as a table processing system 116, for further processing. For example, table processing system 116 can index the information included in the table into one or more data repositories.

As described above, an image-based document can include one or more tables. Each table can include differing features. For example, tables can include varying numbers of rows/columns, differing bordering features, different alignments of cells in the table, etc.

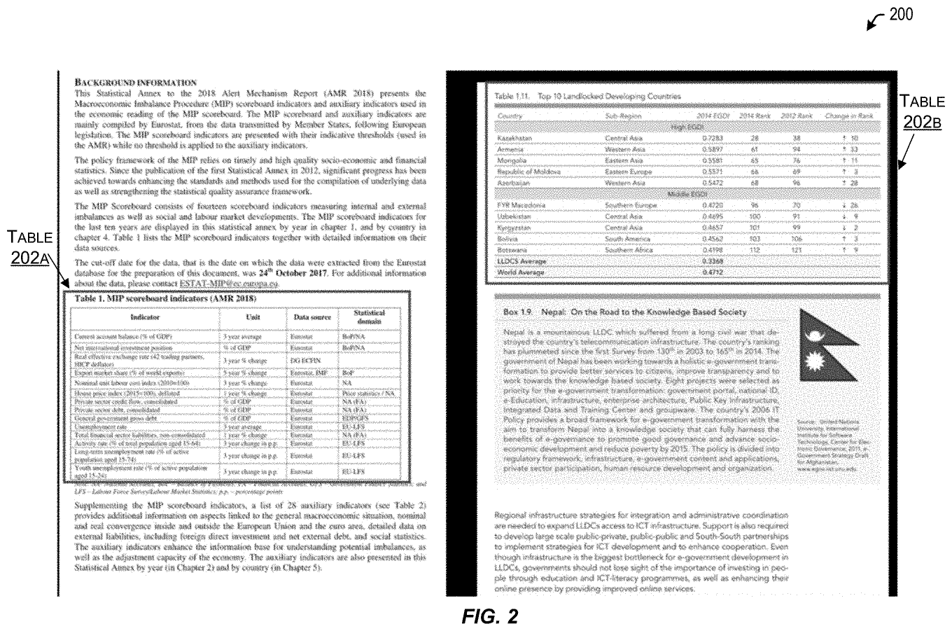

FIG. 2 provides a first set of example image-based documents 200 comprising tables 202A-B. For example, a first table 202A can include multiple rows/columns that are clearly defined using a series of lines bordering each cell in the table 202A. A second table 202B can differ from that in the first table 202A in that the second table 202B is semi-bordered in that only rows in the table 202B include bordering lines.

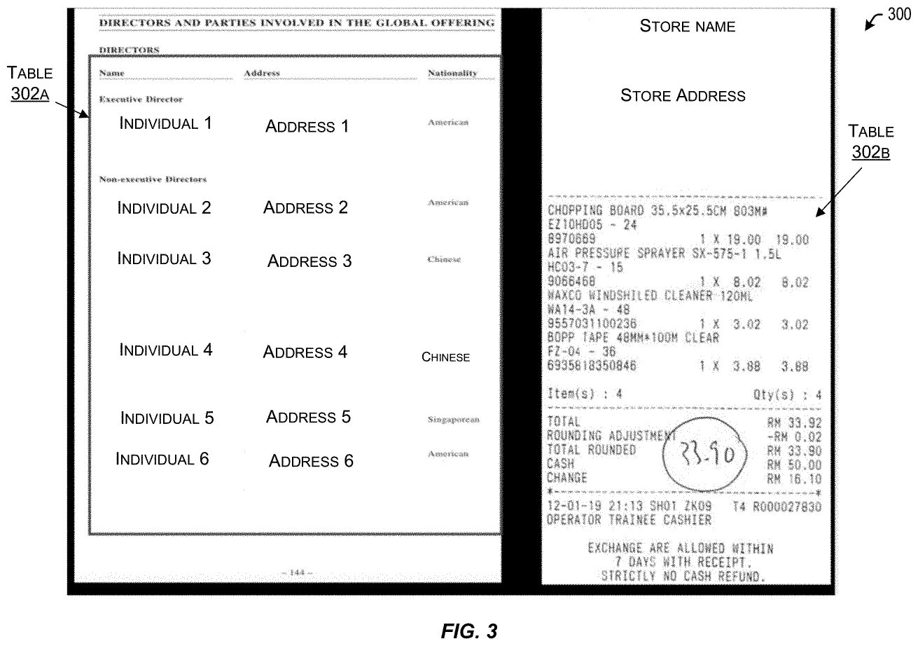

FIG. 3 provides a second set of example image-based documents 300 comprising tables 302A-B. For example, a first table 302A can include a borderless table providing no lines bordering any cells in the table. As another example, a second table 302B can specify a receipt for multiple goods and a value associated with each of the multiple goods. Further, the alignment of a row may not be consistent for each row. For example, as shown in the second table 302B, a first cell can specify a “chopping board” and a second cell in the row can specify “19.00,” despite the cells not being directly aligned with one another. Such differences in tables across image-based documents can increase a difficulty in identifying tables and/or cells within the tables.

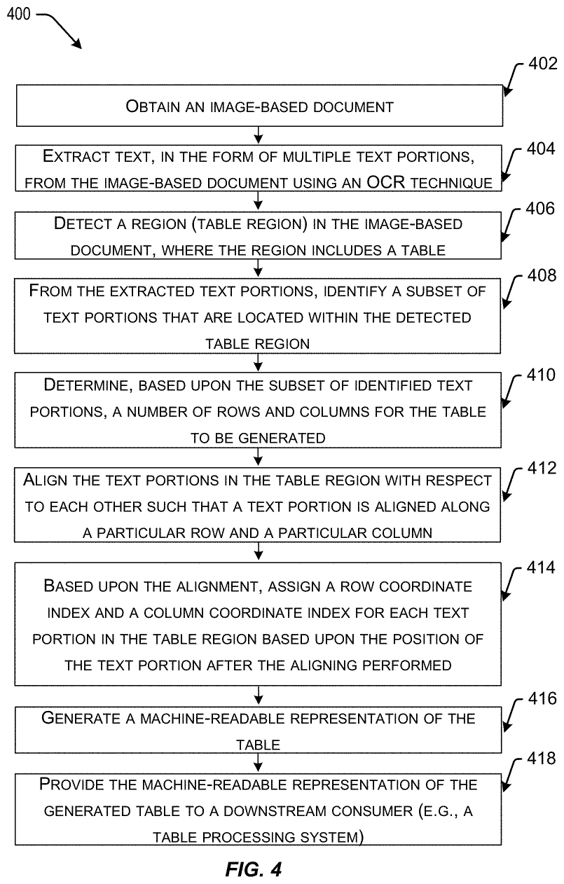

FIG. 4 depicts a simplified flowchart 400 depicting processing performed for extracting a table from an image-based document and generating a machine-readable table representation corresponding to the table according to certain embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIG. 4 may be performed by table identification and extraction system 100 and its subsystems.

The processing may be triggered, at 402, when an image-based document is received from which table information is to be extracted. For example, table identification and extraction system 100 depicted in FIG. 1 may receive image-based document 104 for processing. In certain instances, table identification and extraction system 100 may receive a request requesting table extraction and the image-based document may be included in the request.

The image-based document may be received from different sources. In one use case, the image-based document may be received from a user device that generated the image-based document. For example, a user may use a user device such as a scanner or a camera to generate the image-based document. The user may then send a request from the user device to the table identification and extraction system where the request includes the image-based document to be processed. For instance, a camera on a client device can capture an image of a receipt, such as receipt 500A as shown in FIG. 5A and send the receipt image-based document to a table identification and extraction system. In another user case, the table identification and extraction system may receive information identifying the image-based document and may then access the image-based document from a memory location where the image-based document is stored.

At 404, one or more optical character recognition (OCR) techniques are used to extract text content from the image-based document received in 402. The text content extracted in 404 may be in the form of multiple text portions, each text portion corresponding to portion of the text content in the image-based document. In certain implementations, the image-based document may be processed, and the OCR performed on a line-by-line basis. A text portion may correspond to text content in a line in the image-based document, or some portion of the text content in the line. In certain implementations, each extracted text portion is bounded by a bounding box and is associated with location information, where the location information specifies a location of the text portion in the image-based document.

For example, in the embodiment depicted in FIG. 1, the processing in 404 may be performed by OCR subsystem 106. OCR subsystem 106 may receive image-based document 104 as input, apply OCR techniques to the image-based document to extract a set of text portions from the image-based document. OCR subsystem 106 may then provide the extracted text portions to table detection subsystem 102 for further analysis.

At 406, a region (table region) in the image-based document can be detected. The image-based document can be processed to detect a region (referred to as a table region) within the image-based document that comprises a table. The table region detected in 406 identifies the boundaries of the table in the image-based document. As part of the processing in 406, position information is determined for the detected table region, where the position information identifies the location of the detected table region in the image-based document. For example, the position information may include location coordinates for the table region indicative of the position of the table region within the image-based document. The processing in 406 does not attempt to detect components (e.g., cells, rows, columns) of the table. Instead, only the region of the image-based document potentially containing data in a table format is detected in 406. For example, for the example receipt image-based document depicted in FIG. 5B, as part of the processing in 406, region 502 comprising table data may be identified in the image-based document 500B.

Various different techniques may be used to detect a table region in 406. According to one technique, the region can be detected based on the positions of bounding boxes on the image-based document. A trained model (e.g., 109 in FIG. 1) can be used by a table region identification subsystem (e.g., 108) to identify the table region. In some instances, the positions (e.g., coordinates) of each bounding box and/or bordering lines in the image-based document can be used to detect the region comprising the table.

If there are multiple tables in the image-based document, then multiple table regions may be detected in 406, each table region corresponding to a table in the image-based document. In such instances, the processing depicted in FIG. 4 and described below can be repeated for each identified table region.

At 408, the process can include, from the text portions extracted in 404, identifying a subset of text portions that are located within the table region detected in 406. From the text portions extracted in 404, a set of text portions that are located within the table region detected in 406 can be identified. The number of text portions identified in 408 is typically smaller (and in many instances, significantly smaller) than the number of text portions identified in 404. The text portions identified in 408 thus represent a subset of the text portions extracted in 404.

Various different techniques may be used in 408 to identify the text portions that are located in the table region detected in 406. According to one technique, the identification of the subset is done based upon the position information associated with text portions extracted in 404 (e.g., position coordinates of the bounding boxes of the text portions) and the position information determined for the table region in 406. Based upon this position information, as part of the processing 408, those text portions whose bounding boxes are completely within the boundaries of the table region detected in 408 are identified as being located within the table region. In certain implementations, even if a bounding box corresponding to a text portion is not completely within the boundaries of the table region, if the overlap between the bounding box and the table region is above some pre-configured threshold (e.g., over 80%), then the text portion corresponding to that bounding box may still be considered to be within the table region and identified as such in 408.

In certain implementations, the subset of text portions identified in 408 represent cells of a table to be generated. Each text portion may represent a cell of the table that will be generated (generated in 416). Accordingly, the text portions identified in 408 can also be referred to as cells of a table.

For example, in the embodiment depicted in FIG. 1, the processing in 408 is performed by a table cells identification subsystem 110. For instance, the table cells identification subsystem 110 can identify the text portions that are located in the table region detected in 406.

At 410, the process can include determining, based upon the subset of text portions identified in 408, a number of rows and columns for the table to be generated. This can include determining a number of rows and columns for the table to be generated are computed based upon the text portions identified in 408. Various techniques are used to determine the number of rows and columns. According to one technique, the number of rows and columns can be derived by allocating a row and a column index to the cells. Each cell can be assigned the row and the column index via a table structural segmentation (TSS) process.

In some instances, the rows and columns can be detected by identifying a maximum number of rows and columns by expanding text bounding boxes until any of the bounding boxes reach adjacent bounding boxes. For example, in FIG. 5B, based upon the text portions identified as located within table region 502, the table identification and extraction system may compute that the machine-readable table representation to be generated is to contain two columns and five rows. Coordinates corresponding with each bounding box can be expanded until coordinates of the bounding box corresponds with (e.g., overlaps with) coordinates of another bounding box of another text portion.

For example, in the embodiment depicted in FIG. 1, the processing in 410 is performed by table cells identification subsystem 110. The table cells identification subsystem 110 can identify the number of rows and columns for the table to be generated based upon the text portions identified in 408.

At 412, the process can include aligning the text portions in the table region with respect to each other such that a text portion is aligned along a particular row and a particular column. The text portions identified in 408 (or cells) can be aligned with respect to each other such that text portions are aligned along particular rows and columns, where the number of rows and columns is as per the numbers computed in 410. The alignment performed in 412 is such that each cell or text portion lies in one row and one column. The alignment of the text portions can be used for assigning row and column identifiers to the text portions in 414.

For example, in the embodiment depicted in FIG. 1, the processing in 412 is performed by the row-column coordinates assignment subsystem 112.

At 414, based upon the alignment performed in 412, a row and a column coordinate or index is assigned to each text portion (or cell) based upon the position of the text portion after the aligning. The row and column assigned to a text portion denotes a cell position of the text portion within the table to be generated. For instance, in the example in FIG. 5B, text portion 504A containing text “Coffee” may be assigned a row identifier of “1” and a column identifier of “1” indicating that text portion 504A represents the cell in the first row and first column of the table to be generated. Likewise, text portion 504B containing text “2.95” may be assigned a row identifier of “1” and a column identifier of “2” indicating that text portion 504B represents the cell in the first row and second column of the table to be generated. In a similar manner, row and column indices are assigned to the text portions identified in 408 where the indices are indicative of the cell positions of the text portions within the machine-readable table to be generated.

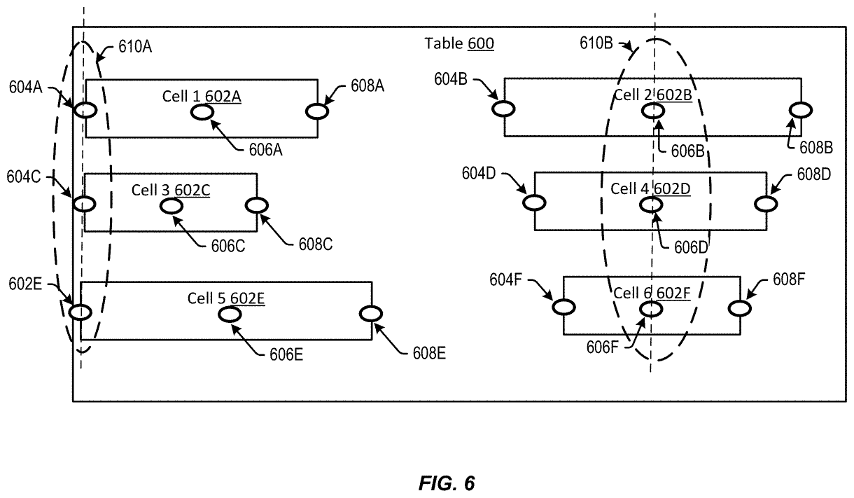

In some instances, a clustering technique can be used to assign row and column indices to the text portions. The text portions in the subset may be clustered based upon their position information. For example, text portions having similar “Y” positional coordinates may represent text portions belonging to the same row. Accordingly, text portions in the subset may be clustered based upon associated “Y” coordinate information. This may result in a set of clusters of text portions, where the text portions in a cluster represent text portions belonging to the same row. Text portions having similar “X” positional coordinates may represent text portions belonging to the same column. Accordingly, text portions in the subset may be clustered based upon associated “X” coordinate information. This may result in a set of clusters of text portions, where the text portions in a cluster represent text portions belonging to the same column. Clustering is described in greater detail with respect to FIG. 6.

For example, in the embodiment depicted in FIG. 1, the processing in 414 is performed by the row-column coordinates assignment subsystem 112.

At 416, a machine-readable table representation is generated based upon the text portions identified in 406 and the row and column indices determined for the text portions in 414. The table generated in 416 contains the number of rows and columns determined in 410. The subset of text portions determined in 406 represent the cells of the generated table, where the row and column indices assigned to the text portions in 414 represent the cell positions for the text portions within the generated table. For example, a text portion with assigned row index “1” and column index “1” is a cell in the first row and first column in the generated table, and the text content of the text portion represents the value entered in that cell. In general, a text portion with assigned row index “n” and column index “m” is a cell in the “n^{th}” row and “m^{th}” column of the generated table, and the text content of that text portion represents the value entered in that cell. For example, table 500C depicted in FIG. 5C may be generated for table region 502 of the receipt image-based document depicted in FIG. 5B.

The machine-readable table representation generated be in different formats. Examples of formats include without limitation, an editable table (e.g., a table format understandable and readable by a word processing or document editing program), a spreadsheet (e.g., readable by program such as MS EXCEL), a JSON (JavaScript Object Notation) object, an XML file or object, and the like.

For example, in the embodiment depicted in FIG. 1, the processing in 416 is performed by table generation subsystem 114.

At 418, one or more actions or processing may be performed using the machine-readable table representation generated in 416. For example, the generated table may be provided as input to a downstream consumer of the table. For example, the table may be provided to a table processing system for subsequent processing. For example, the table processing system can process the machine-readable table representation such as to extract text contents of the table and perform processing based upon the contents. For example, for the expense reimbursement example described earlier, the table may be provided to a program that generates an itemized list of the dinner expenses, calculates the total amount to the reimbursed by adding the dollar amounts in the table cells, and then initiates the reimbursement. In certain implementations, this entire workflow, starting from receiving the receipt image-based document to processing the reimbursement may be completely automated substantially free of any human processing.

For example, in the embodiment depicted in FIG. 1, the machine-readable table representation 115 that is generated by table identification and extraction system 100 is provided to a table processing system 116, which may be configured to process the table entries.

As described above, a table identification and extraction system can identify a region comprising a table in an image-based document, assign rows/column identifiers to text portions within the region, and generate a machine-readable representation of the table. FIGS. 5A-5C illustrate examples 500A-C of identifying a table and generating a machine-readable version of a table in an image-based document.

FIG. 5A is an example image-based document 500A. In this example, the image-based document can include a receipt (e.g., provided by a resource provider). Further, the image-based document 500A can include a plurality of text lines and a table. While a receipt is used as an illustrative example, any type of image-based document can be processed as described herein. The image-based document 500A can be electronically scanned (e.g., from a scanning device) and provided to the cloud infrastructure service. The cloud infrastructure service can implement the table identification and extraction system as described herein.

FIG. 5B illustrates the identified table and cells of the table in the image-based document 500B. As shown in FIG. 5B, a number of text portions (e.g., 504A-B) can be identified. For example, each text portion can be identified using an OCR process. Further, a region comprising a table 502 can be identified in the image-based document. The region comprising the table 502 can include a region in the image-based document in which a table exists. For example, the table 502 comprises two columns and five rows, with each cell comprising a text portion (e.g., 504A-B).

In some instances, the cells in the table can be identified based on derived alignments for each cell. For example, a center, left, and right alignment (e.g., x-y axis coordinates) can be derived for each cell. The alignment of the cells can be used to assign each cell to rows/columns in the table.

Further, a clustering technique can be used to derive groups of cells. For example, as shown in FIG. 5B, a cluster 506 can identify a group of cells part of a single column. Multiple clusters can be generated to group cells for assigning row/column identifiers to each cell. Clustering is further described in FIG. 6.

FIG. 5C illustrates an example table in a machine-readable format 500C. The table 500C can comprise text portions (e.g., 508A-B) in a Unicode or similar format, allowing for text to be identified and extracted. For example, the table data can be stored in a repository for subsequent querying/retrieval. As another example, the table data can be provided to an application, such as an accounting application for use in tracking transactions specified in the table data.

As described above, a row/column identifier can be assigned to each identified cell in a table. Further, identifying a position of each cell in a table can be based on a clustering technique. Clustering can include identifying groups of cells with a common alignment. For example, a first cluster of cells can include cells part of a single column, while a second cluster can include cells that are part of a row. FIG. 6 is a block diagram of a table 600 comprising a number of cells with alignment position and grouped by multiple clusters.

As shown in FIG. 6, the table 600 can include a number of cells 602A-F. Each cell 602A-F can include a portion of text as part of the table. For example, a first group of cells (e.g., cells 602A, 602C, 602E) can include text comprising names of items and a second group of cells (e.g., cells 602B, 602D, 602F) can include text comprising a quantity or value for the items.

Further, each cell 602A-F can comprise a position in the table 600. The position can be specified by a number of alignment points, such as left alignments 604A-F, center alignments 606A-F, and right alignments 608A-F. Each alignment can specify coordinates (e.g., x/y coordinates) providing a position of each cell in the table 600.

Further, the alignment coordinates can be used to generate clusters grouping the cells by rows and columns. For example, as shown in FIG. 6, a first grouping of cells 602A, 602C, 602E can include left alignments 604A, 604C, 604E with a similar x coordinate, specifying the cells are all part of a first column. Similarly, a second grouping of cells 602B, 602D, 602F can include center alignments 606B, 606D, 606F with a similar x coordinate, specifying the cells are all part of a second column. Clusters (e.g., 610A-B) can be formed by determining alignments within a threshold proximity to one another, providing groups of cells part of rows/columns. Other clusters can group cells by row by identifying cells with similar y coordinates, such as cell 1 602A and cell 2 602B, for example.

In some instances, the table identification and extraction system as described herein can be trained. This can include providing the system training samples with known results to improve accuracy and efficiency in identifying table data as described herein. For instance, a plurality of training samples specifying varying table types with known results can be stored for use in training the model.

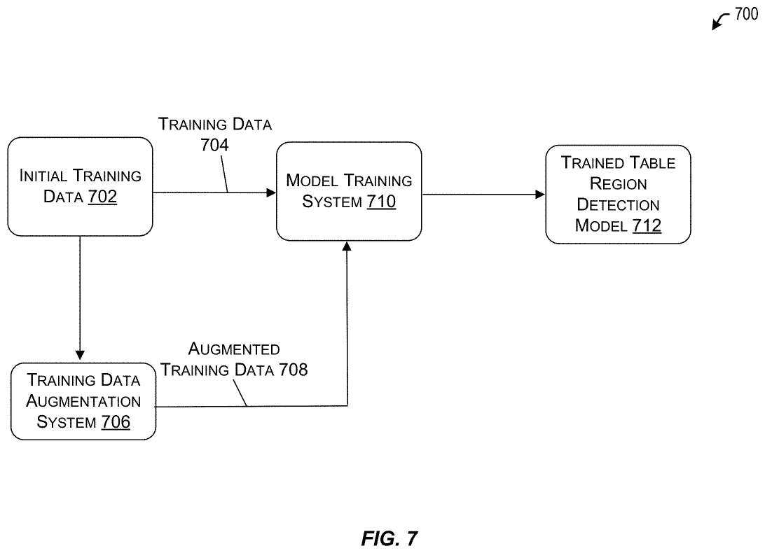

FIG. 7 is a flow diagram of an example process 700 for training a model, according to at least one embodiment. Initial training data 702 can be obtained for training the model. For instance, initial training data can be stored at a data repository. Training data can include a table that is part of an image-based document and corresponding known results. The known results can include known text/table data included in the table of each image-based document. The known results can be used to identify an accuracy in identifying table data. Further, changes to the system can be made based on the identified accuracy in processing the training data. The training data 704 can be provided to a model training system 710.

Further, the training data can be provided to a training data augmentation system 706. The training data augmentation system 706 can augment the training data. For example, augmenting the data can include any of: rotation, dilation, random Hue, Saturation, & Lightness (HSL), image blurring, morphological, image sharpening, top hat, back hat, edge detection, etc.), etc. Augmenting the training data can result in increased difficulty in identifying table data part of the image-based documents. The augmented training data 708 can be provided to the model training system 710.

The model training system 710 can train the model (e.g., the trained table region detection model 712). The training data can be used to train the trained table region detection model 712 and increase accuracy in identifying region(s) comprising a table in image-based documents. For example, the augmented training data can be used to identify regions comprising table(s) in documents with various augmentations to the training data. The training of the trained table region detection model 712 can allow for the periodic increase in accuracy in identifying the region(s) comprising a table in image-based documents.

As previously discussed, the task of extracting tables from an image-based document (e.g., an image of a receipt) was often done manually. This is however extremely labor intensive, time consuming, and expensive, and thus not very scalable. Further automated techniques that are presently used to perform this task need high-speed computational resources and suffer from high latency, and additionally suffer from high error rates.

Accordingly, the techniques described herein provide significant improvements over conventional table extraction techniques. For example, the techniques described herein are less compute intensive and faster than existing table extraction techniques. The techniques described herein are also more robust (i.e., less error prone) and accurate than existing table-extraction techniques, making the described techniques well suited for extracting tables from image-based documents that have been traditionally difficult for existing table extraction techniques to process, such as, for example, extracting tables from images of receipts. The resource and latency/time savings provided by the embodiments described herein enable the table extraction processing to be performed in real time while consuming fewer computational resources that conventional techniques.

In certain embodiments, the table extraction functionality described in this disclosure may be offered as a cloud service by a cloud services provider (CSP) to its subscribing customers. In certain implementations, the functionality may be offered to subscribing customer under a Software-as-a-Service (SaaS) model. In some implementations, an Infrastructure-as-a-Service (IaaS) provider may offer the service as part of its infrastructure offerings. The following sections describes an IaaS implementation that may offer various cloud services to subscribing customers. The image-based document processing, table extraction, and the generation of a machine-readable representation of the table functionality disclosed in this disclosure may be offered as one of the cloud services.

### Example IaaS Implementation

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may first need (or, alternatively, be desired/expected) to be set up. In some instances, the provisioning can be done manually, a provisioning tool may be utilized to provision the resources, and/or deployment tools may be utilized to deploy the code once the infrastructure is provisioned.

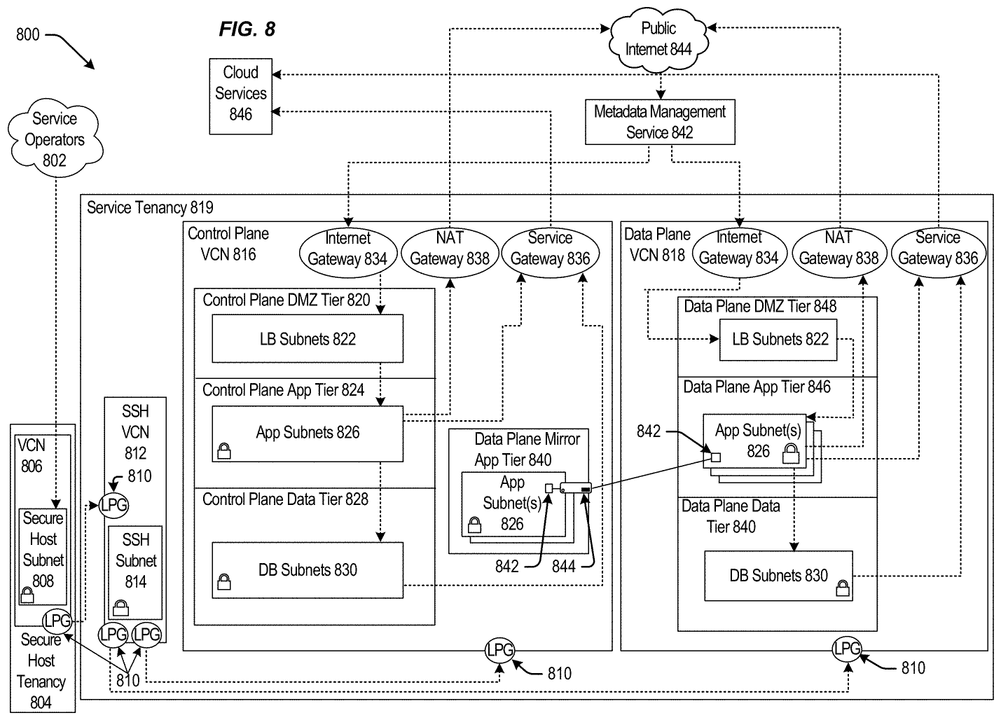

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Memory that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

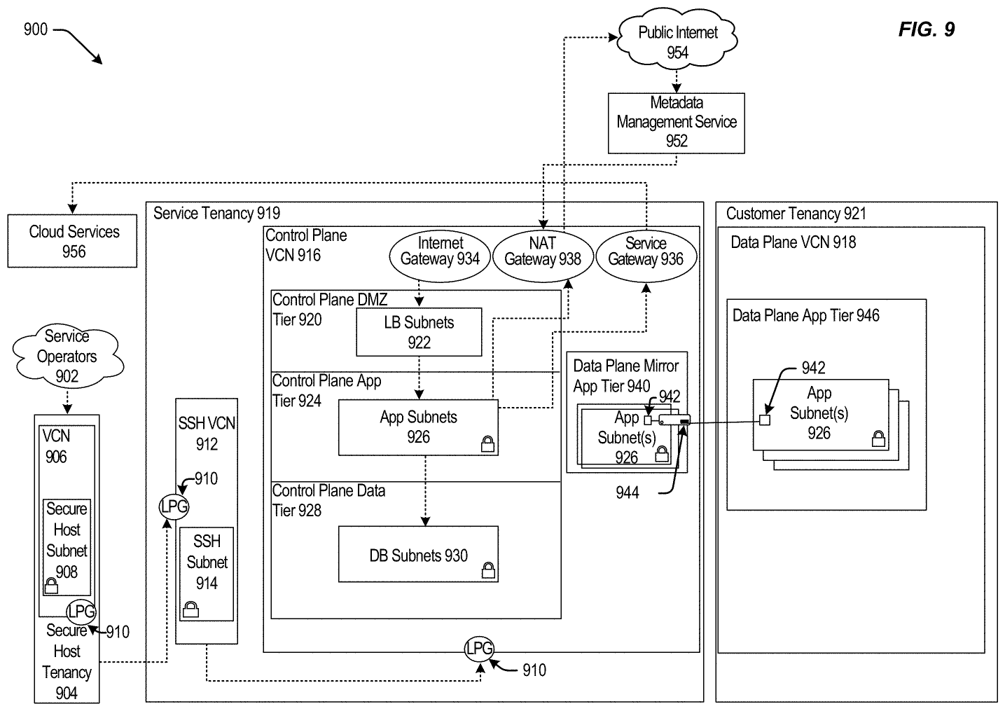

FIG. 9 is a block diagram 900 illustrating another example pattern of an IaaS architecture, according to at least one embodiment. Service operators 902 (e.g. service operators 802 of FIG. 8) can be communicatively coupled to a secure host tenancy 904 (e.g. the secure host tenancy 804 of FIG. 8) that can include a virtual cloud network (VCN) 906 (e.g. the VCN 806 of FIG. 8) and a secure host subnet 908 (e.g. the secure host subnet 808 of FIG. 8). The VCN 906 can include a local peering gateway (LPG) 910 (e.g. the LPG 810 of FIG. 8) that can be communicatively coupled to a secure shell (SSH) VCN 912 (e.g. the SSH VCN 812 of FIG. 8) via an LPG 810 contained in the SSH VCN 912. The SSH VCN 912 can include an SSH subnet 914 (e.g. the SSH subnet 814 of FIG. 8), and the SSH VCN 912 can be communicatively coupled to a control plane VCN 916 (e.g. the control plane VCN 816 of FIG. 8) via an LPG 910 contained in the control plane VCN 916. The control plane VCN 916 can be contained in a service tenancy 919 (e.g. the service tenancy 819 of FIG. 8), and the data plane VCN 918 (e.g. the data plane VCN 818 of FIG. 8) can be contained in a customer tenancy 921 that may be owned or operated by users, or customers, of the system.

The control plane VCN 916 can include a control plane DMZ tier 920 (e.g. the control plane DMZ tier 820 of FIG. 8) that can include LB subnet(s) 922 (e.g. LB subnet(s) 822 of FIG. 8), a control plane app tier 924 (e.g. the control plane app tier 824 of FIG. 8) that can include app subnet(s) 926 (e.g. app subnet(s) 826 of FIG. 8), a control plane data tier 928 (e.g. the control plane data tier 828 of FIG. 8) that can include database (DB) subnet(s) 930 (e.g. similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g. the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g. the service gateway of FIG. 8) and a network address translation (NAT) gateway 938 (e.g. the NAT gateway 838 of FIG. 8). The control plane VCN 916 can include the service gateway 936 and the NAT gateway 938.

The control plane VCN 916 can include a data plane mirror app tier 940 (e.g. the data plane mirror app tier 840 of FIG. 8) that can include app subnet(s) 926. The app subnet(s) 926 contained in the data plane mirror app tier 940 can include a virtual network interface controller (VNIC) 942 (e.g. the VNIC of 842) that can execute a compute instance 944 (e.g. similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g. the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g. the metadata management service 852 of FIG. 8) that can be communicatively coupled to public Internet 954 (e.g. public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g. cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

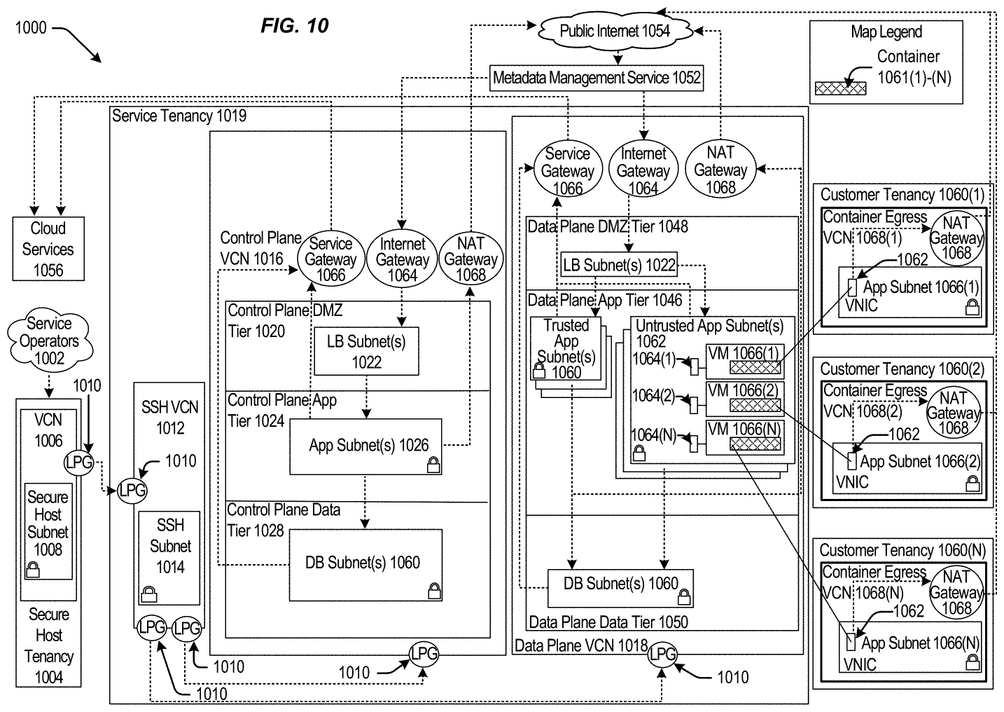

FIG. 10 is a block diagram 1000 illustrating another example pattern of an IaaS architecture, according to at least one embodiment. Service operators 1002 (e.g. service operators 802 of FIG. 8) can be communicatively coupled to a secure host tenancy 1004 (e.g. the secure host tenancy 804 of FIG. 8) that can include a virtual cloud network (VCN) 1006 (e.g. the VCN 806 of FIG. 8) and a secure host subnet 1008 (e.g. the secure host subnet 808 of FIG. 8). The VCN 1006 can include an LPG 1010 (e.g. the LPG 810 of FIG. 8) that can be communicatively coupled to an SSH VCN 1012 (e.g. the SSH VCN 812 of FIG. 8) via an LPG 1010 contained in the SSH VCN 1012. The SSH VCN 1012 can include an SSH subnet 1014 (e.g. the SSH subnet 814 of FIG. 8), and the SSH VCN 1012 can be communicatively coupled to a control plane VCN 1016 (e.g. the control plane VCN 816 of FIG. 8) via an LPG 1010 contained in the control plane VCN 1016 and to a data plane VCN 1018 (e.g. the data plane 818 of FIG. 8) via an LPG 1010 contained in the data plane VCN 1018. The control plane VCN 1016 and the data plane VCN 1018 can be contained in a service tenancy 1019 (e.g. the service tenancy 819 of FIG. 8).

The control plane VCN 1016 can include a control plane DMZ tier 1020 (e.g. the control plane DMZ tier 820 of FIG. 8) that can include load balancer (LB) subnet(s) 1022 (e.g. LB subnet(s) 822 of FIG. 8), a control plane app tier 1024 (e.g. the control plane app tier 824 of FIG. 8) that can include app subnet(s) 1026 (e.g. similar to app subnet(s) 826 of FIG. 8), a control plane data tier 1028 (e.g. the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 8) and a network address translation (NAT) gateway 1038 (e.g. the NAT gateway 838 of FIG. 8). The control plane VCN 1016 can include the service gateway 1036 and the NAT gateway 1038.

The data plane VCN 1018 can include a data plane app tier 1046 (e.g. the data plane app tier 846 of FIG. 8), a data plane DMZ tier 1048 (e.g. the data plane DMZ tier 848 of FIG. 8), and a data plane data tier 1050 (e.g. the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g. public Internet 854 of FIG. 8).

The Internet gateway 1034 contained in the control plane VCN 1016 and contained in the data plane VCN 1018 can be communicatively coupled to a metadata management service 1052 (e.g. the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

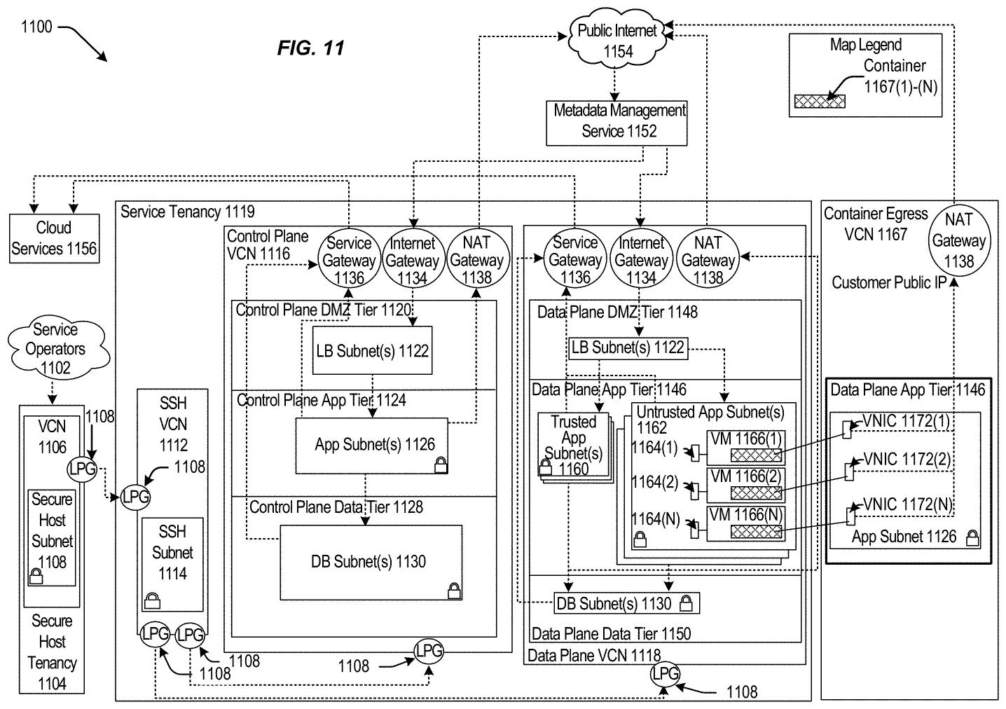

FIG. 11 is a block diagram 1100 illustrating another example pattern of an IaaS architecture, according to at least one embodiment. Service operators 1102 (e.g. service operators 802 of FIG. 8) can be communicatively coupled to a secure host tenancy 1104 (e.g. the secure host tenancy 804 of FIG. 8) that can include a virtual cloud network (VCN) 1106 (e.g. the VCN 806 of FIG. 8) and a secure host subnet 1108 (e.g. the secure host subnet 808 of FIG. 8). The VCN 1106 can include an LPG 1110 (e.g. the LPG 810 of FIG. 8) that can be communicatively coupled to an SSH VCN 1112 (e.g. the SSH VCN 812 of FIG. 8) via an LPG 1110 contained in the SSH VCN 1112. The SSH VCN 1112 can include an SSH subnet 1114 (e.g. the SSH subnet 814 of FIG. 8), and the SSH VCN 1112 can be communicatively coupled to a control plane VCN 1116 (e.g. the control plane VCN 816 of FIG. 8) via an LPG 1110 contained in the control plane VCN 1116 and to a data plane VCN 1118 (e.g. the data plane 818 of FIG. 8) via an LPG 1110 contained in the data plane VCN 1118. The control plane VCN 1116 and the data plane VCN 1118 can be contained in a service tenancy 1119 (e.g. the service tenancy 819 of FIG. 8).

The control plane VCN 1116 can include a control plane DMZ tier 1120 (e.g. the control plane DMZ tier 820 of FIG. 8) that can include LB subnet(s) 1122 (e.g. LB subnet(s) 822 of FIG. 8), a control plane app tier 1124 (e.g. the control plane app tier 824 of FIG. 8) that can include app subnet(s) 1126 (e.g. app subnet(s) 826 of FIG. 8), a control plane data tier 1128 (e.g. the control plane data tier 828 of FIG. 8) that can include DB subnet(s) 1130 (e.g. DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g. the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g. the service gateway of FIG. 8) and a network address translation (NAT) gateway 1138 (e.g. the NAT gateway 838 of FIG. 8). The control plane VCN 1116 can include the service gateway 1136 and the NAT gateway 1138.

The data plane VCN 1118 can include a data plane app tier 1146 (e.g. the data plane app tier 846 of FIG. 8), a data plane DMZ tier 1148 (e.g. the data plane DMZ tier 848 of FIG. 8), and a data plane data tier 1150 (e.g. the data plane data tier 850 of FIG. 8). The data plane DMZ tier 1148 can include LB subnet(s) 1122 that can be communicatively coupled to trusted app subnet(s) 1160 (e.g. trusted app subnet(s) 1060 of FIG. 10) and untrusted app subnet(s) 1162 (e.g. untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g. public Internet 854 of FIG. 8).

The Internet gateway 1134 contained in the control plane VCN 1116 and contained in the data plane VCN 1118 can be communicatively coupled to a metadata management service 1152 (e.g. the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

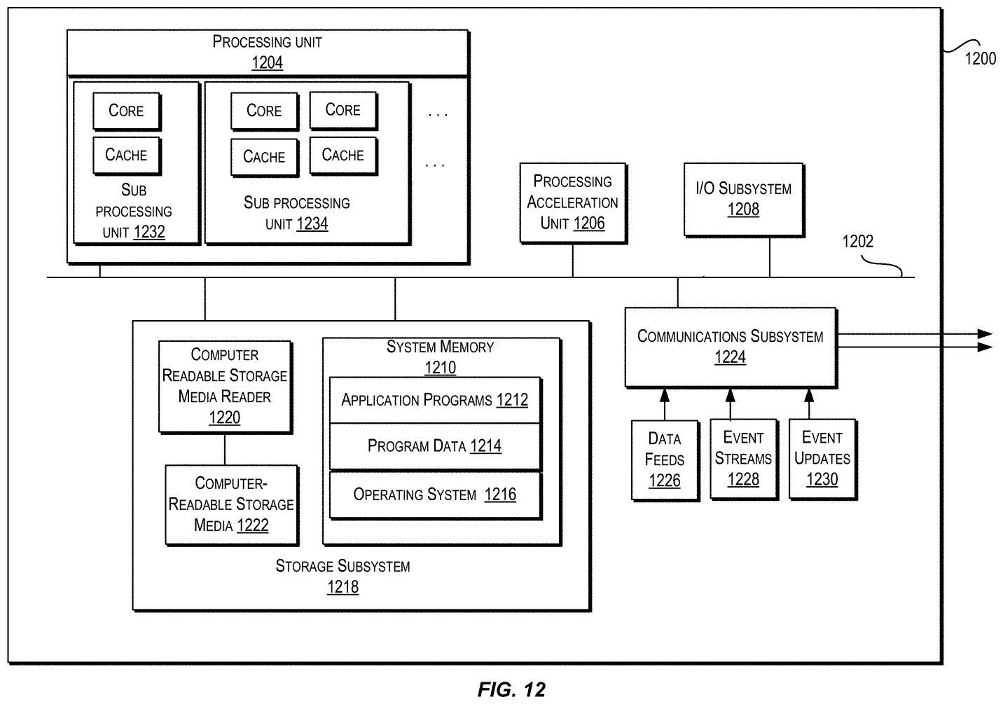

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 12 OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 1002.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Example embodiments of this disclosure are described herein, including the best mode known for carrying out the disclosure. Variations of those example embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method performed by a computer system, the method comprising:
extracting a plurality of text portions from an image-based document, each text portion corresponding to a portion of text content in the image-based document, the image-based document comprising a plurality of pixels;
detecting a table region within the image-based document;
identifying, from the plurality of text portions, a set of one or more text portions located within the table region in the image-based document;
assigning a row index and a column index to each text portion in the set of text portions; and
generating a machine-readable representation of a table based upon the set of text portions and the row index and the column index assigned to each of the text portions in the set of text portions, wherein each text portion in the set of text portions corresponds to a cell of the generated machine-readable representation of the table.

2. The method of claim 1, wherein extracting the plurality of text portions comprises using an optical character recognition (OCR) technique to extract the plurality of text portions from the image-based document.

3. The method of claim 1, wherein, for a text portion from the set of text portions, the row index and the column index assigned to the text portion indicates a position of the text portion within the table.

4. The method of claim 1, further comprising deriving a number of rows and a number of columns for the table based upon the set of text portions and positions of the text portions within the table region in the image-based document.

5. The method of claim 4, wherein deriving the number of rows and the number of columns for the table based upon the set of the text portions comprises:
for at least one text portion in the set of text portions, expanding a bounding box of the text portion until coordinates of the bounding box corresponds with coordinates of another bounding box of another text portion from the set of text portions.

6. The method of claim 1, further comprising:
computing a number of rows and a number of columns for the table based upon the set of the text portions and positions of the text portions within the table region in the image-based document; and
aligning the set of text portions resulting in each text portion in the set of text portions being aligned to a row from the number of rows and a column from the number of columns,
wherein assigning the row index and the column index to each text portion in the set of text portions comprises assigning the row index and the column index to each text portion in the set of text portions based upon a position of the text portion after the aligning.

7. The method of claim 1, further comprising providing the generated machine-readable representation of the table to a table processing system for subsequent processing.

8. The method of claim 1, wherein the machine-readable representation of the table is an editable table, a spreadsheet, a JSON (JavaScript Object Notation) object, an XML file, or an XML object.

9. The method of claim 1, wherein assigning the row index and the column index to each text portion in the set of text portions comprises:
clustering the set of text portions based upon positions of the set of text portions within the table region; and
assigning the row index and the column index to each text portion in the set of text portions based upon the clustering.

10. A table identification and extraction system comprising:
a processor; and
a computer-readable medium including instructions stored thereon that, when executed by the processor, cause the processor to perform processing comprising:
obtaining an image-based document;
processing the image-based document to:
extract a series of text portions in the image-based document; and
detect a region within the image-based document comprising a table;
identifying a subset of the series of text portions that are located within the region comprising the table, each of the subset of the series of text portions comprising a cell within the table;
deriving a set of clusters within the region comprising the table, each cluster grouping text portions that are part of a row or a column;
assigning, for each of the subset of the series of text portions, a row identifier and a column identifier according to a number of rows and columns for the table and the derived set of clusters;
generating a machine-readable version of the table that includes each of the subset of the series of text portions arranged according to the assigned row identifiers and column identifiers; and
providing the generated table to a table processing system for subsequent processing.

11. The table identification and extraction system of claim 10, wherein the image-based document is received by a client device configured to generate the image-based document via a scanning module of the client device.

12. The table identification and extraction system of claim 10, wherein the region within the image-based document comprising the table is bounded by a bounding box including two-dimensional coordinates specifying a position of the table in the image-based document.

13. The table identification and extraction system of claim 10, wherein the instructions further cause the processor to perform processing comprising:
comparing text portions in the machine-readable version of the table with a known output for the image-based document to derive an accuracy in extracting text in the table, wherein the derived accuracy is used to train a model for detecting region within the image-based document comprising the table.

14. The table identification and extraction system of claim 10, wherein the instructions further cause the processor to perform processing comprising:
identifying an alignment of each of the subset of text portions by deriving a coordinate position of each of the subset of text portions, wherein the row and column identifiers are assigned to each cell based on the derived coordinate positions.

15. The table identification and extraction system of claim 14, wherein deriving each of set of clusters includes identifying a grouping of text portions with at least one coordinate being within a threshold similarity, indicating that the grouping of text portions are part of a single row or column.

16. The table identification and extraction system of claim 10, wherein deriving the number of rows and columns for the table includes expanding bounding boxes for each of the subset of the series of text portions until any of the bounding boxes reach another bounding box.

17. A non-transitory computer-readable medium including stored thereon a plurality of instructions, which when executed by a processor causes the processor to execute a process comprising:
obtaining an image-based document;
processing the image-based document to:
extract a series of text portions in the image-based document; and
detect a region within the image-based document comprising a table;
identifying a subset of the series of text portions located within the region comprising the table;
deriving a number of rows and columns for the table;
identifying an alignment of each of the subset of the series of text portions by deriving a coordinate position of each subset of the series of text portions;
assigning a row identifier and a column identifier for each of the subset of the series of text portions according to the derived number of rows and columns for the table and the identified alignments based on the derived coordinate position of each subset of the series of text portions;
generating a machine-readable version of the table that includes each of the subset of text portions arranged according to the assigned row identifiers and column identifiers; and
providing the generated table to a table processing system for subsequent processing.

18. The non-transitory computer-readable medium of claim 17, wherein extracting the series of text portions includes performing an optical character recognition (OCR) process to generate the series of text portions into a machine-readable format.

19. The non-transitory computer-readable medium of claim 17, wherein deriving the number of rows and columns for the table includes allocating a row index and a column index to each of the subset of the series of text portions.

20. The non-transitory computer-readable medium of claim 17, wherein deriving the number of rows and columns for the table includes expanding bounding boxes for the subset of the series of text portions until any of the bounding boxes reach another bounding box.
